(19) United States
(12) Patent Application Publication
(10) Pub. No.: US 2007/0117627 A1
(43) Pub. Date: May 24, 2007

(54) Method and system for a similarity-based game

(76) Inventors: Panini D.G. Raman, Palo Alto, CA (US); Anand Venkataraman, Palo Alto, CA (US)

Correspondence Address: Mr. Panini D.G. Raman;Apt. 7, 2456 West Bayshore Road, Palo Alto, CA, 94303, US

(21) Appl. No.: 11/526,937

(22) Filed: Sep. 25, 2006

Related U.S. Application Data
(60) Provisional application No. 60/738,177, filed on Nov. 18, 2005.

(51) Int. Cl. A63F 13/00

(52) U.S. Cl. 463/32

(57) ABSTRACT

In one embodiment, the invention is a method and system for a biometric similarity based game. In one embodiment, photographs of the game players are compared to a celebrity's photograph and the player whose photograph is most similar to that of the celebrity is deemed to be the winner. In another embodiment, voice samples of the players are compared to a celebrity's voice samples and the player whose voice-sample is most similar to that of the celebrity is deemed to be the winner.

### CROSS REFERENCE TO RELATED APPLICATIONS

This application claims the benefit of provisional patent application Ser. No. 60/738,177, filed Nov. 18, 2005, by the same inventors, the entirety of which is incorporated herein by reference.

### FEDERALLY SPONSORED RESEARCH

Not applicable

### FIELD OF THE INVENTION

The present invention relates generally to games and relates more particularly to biometric similarity based games.

### BACKGROUND OF THE INVENTION

Sometimes people are known to remark to others that they look like some well known personality. It is also common for people to wonder whether they look like some famous person and if so by how much. Similarly, it is also known that some people wonder whether their voice, or more particularly their singing voice, or that of their friend, sounds like that of a well known person, especially that of a singer. However, up until now, the only ways in which people could be judged on their similarities to others was through manually mediated celebrity-look-alike contests/games and Karaoke contests/games.

Many people would enjoy a game in which photographs of the players are compared to that of a celebrity, and ranked in order of similarity (or dissimilarity).

Further, many people would enjoy a game in which recorded clips of their voices, especially of their singing voices, are compared to that of a famous singer and ranked in order of similarity (or dissimilarity).

Such a game, if it existed, would benefit greatly from the use of digital cameras and microphones and from computer-mediated ranking. For example, a group of users may decide to play such a game using a computer, wherein they use a digital camera connected to the computer to photograph themselves and have the computer adjudicate similarities of the photographs of the various players to that of some predetermined celebrity.

It is likewise possible to use a microphone connected to a computer to record voice samples of the players and have the computer adjudicate similarities of the voices of the various players to some predetermined celebrity's voice.

Further, such a game will also benefit from the use of digital media, computer networks and mobile devices such as cellular phones, laptop computers and Personal Digital Assistants (PDA). For example, a group of players may congregate to play a celebrity look-alike game in which may use their cellular phone's camera to capture and transmit photographs of themselves and their fellow players to a remotely located computer that calculates the similarities and responds with the results that show the degrees of similarities of the various players to a predetermined celebrity.

Likewise, cellular phones or PDAs could also be used to capture the voices of the players for transmittal to a remote similarity-adjudicating computer.

The reader will appreciate that the adjudicating computer need not necessarily be remotely located. The necessary similarity calculations and adjudication can also be performed on the same device to which the media capturing devices are directly connected.

Thus, there is a need for a method and system for providing a celebrity look-alike or celebrity sound-alike game.

### SUMMARY OF THE INVENTION

In one embodiment, the present invention provides a method and system for a game for a plurality of players wherein players are successively compared with a pre-determined referent and scoring is determined at least in part upon the correspondence of each player to the referent. In one embodiment, the referent is a celebrity whose photo is the object of comparison to the photos of the players. In another embodiment, the referent is a singer, whose voice sample is then the object of comparison to corresponding voice samples of the players. In another embodiment the referent may be a fellow player, or a person selected from some internal database of persons or fictional characters maintained by the game server. The correspondence is determined at least in part on the basis of any quantifiable biometric data relating to the players or the referent. Biometric data means data pertaining to biological or psychological attributes of a person or a fictional character. Quantification refers to the process of deriving measurements.

The invention also provides a system to enable a plurality of players to play a game, wherein the system may be implemented using one or more computers and a communication network.

### BRIEF DESCRIPTION OF THE DRAWINGS

The present invention can be readily understood by considering the following detailed description in conjunction with the accompanying drawings, in which:

FIG. 1 is a flow diagram illustrating one embodiment of a method for implementing one embodiment of the game.

FIG. 2 is a flow diagram illustrating another embodiment of the method wherein correspondence between a player and the referent is determined by the extraction and comparison of characteristic features from their respective representations.

FIG. 3 depicts an architecture of the said embodiment of the game; this embodiment assumes that the game is implemented in a distributed manner as a two-part system.

FIGS. 4, (a) through (d) inclusive depict exemplar user interface screens of one embodiment of a game according to the present invention.

### DETAILED DESCRIPTION

The present invention relates to games and more specifically to celebrity-similarity games, including but not limited to celebrity-look-alike and celebrity-sound-alike games. Such games may be for private or home use (e.g. at private parties or other social gatherings) or at public use (e.g. at bars, night-clubs or television game shows). The method and system of the present invention may be implemented so as to transform virtually any computing device (including a desktop computer, a laptop computer, a cellular telephone, a personal digital assistant (PDA), a wristwatch, a portable video/music player, a car video player/music, a hi-fi/entertainment center, a television, a gaming console, a dedicated video device, a digital camera, a digital video recorder (DVR), a cable or satellite set top box, a dedicated gaming device, among others) into a gaming system capable of capturing photographs or sound samples of game players, comparing the photographs with that of a predetermined celebrity and delivering a judgment as to which player has a photograph that has been deemed to be most similar to that of the selected celebrity. Moreover, the method and system of the present invention may be implemented to score players not only by similarity to celebrities, but also by similarity to fellow players, or to any other persons whose photographs, voice samples or other biometric data may be available.

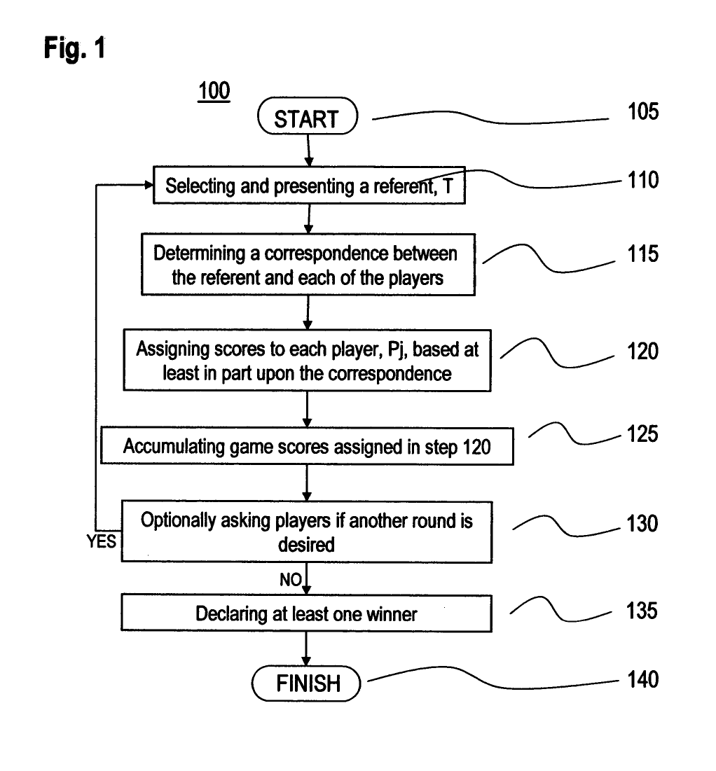

FIG. 1 is a flow diagram illustrating one embodiment of a method 100 for implementing a game according to the present invention. A game according to the method 100 starts at step 105 and proceeds to step 110 wherein a referent is selected from a set of referents which is available to the method and the referent is presented to the players. It can be understood that the presentation of the referent to the players may be effected by means including but not limited to computer screens, speakers, tactile feedback equipment and human or robotic artists.

Next, a correspondence is determined between the selected referent and each of the players in step 115. If the selected referent was an image of a celebrity, then step 115 determines the similarities of images of each of the players in turn to that of the celebrity. If the selected referent was a voice sample of a celebrity, then step 115 determines the similarities of voice samples of each of the players to that of the celebrity.

Using the results of step 115, the method proceeds to the next step, 120, in which scores are assigned to the players based, at least in part, upon the correspondence determined in step 115. In one embodiment of the game method, the maximum score is assigned to the player with the most correspondence to the referent. In another embodiment, the maximum score is assigned to the player with the most correspondence to the referent. Many scoring parameters can be adapted to provide interesting variations of a game according to the method 100.

In step 125 the scores assigned in step 120 are accumulated for each player.

In step 130, a decision is made: If either multiple rounds of play are sought then the method cycles back to step 110 and repeats the procedure until no more rounds are sought at step 130. If multiple rounds of play are not sought, or if the game's embodiment disallows more rounds at this step, then the method proceeds to step 135.

In step 135, the method provides for communicating or declaring as the winner the player with the most points, and proceeds to finish at step 140.

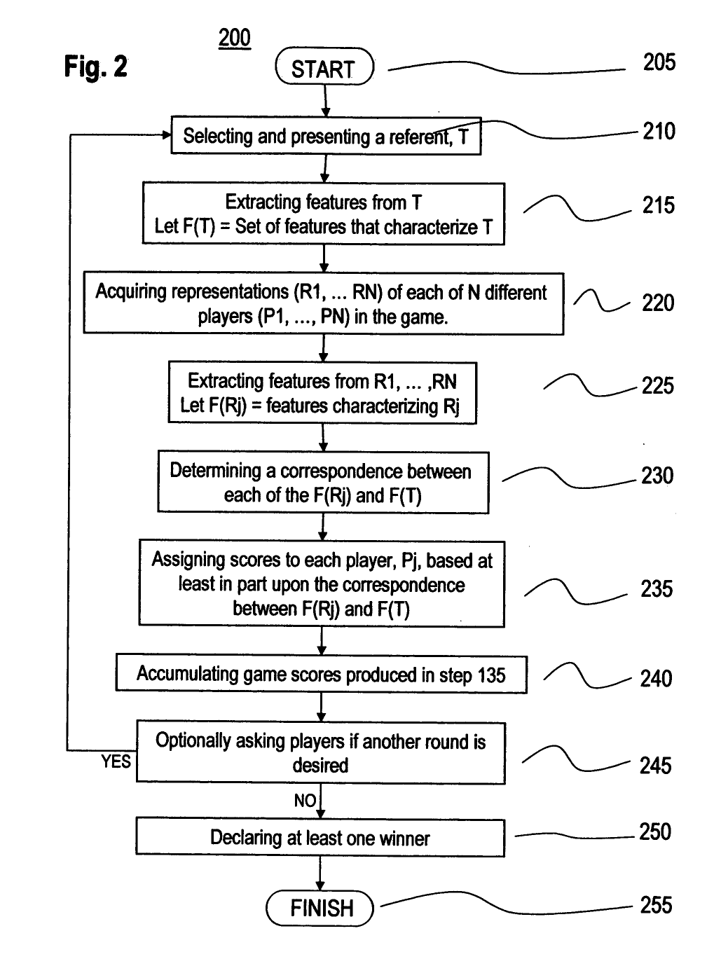

FIG. 2 is a flow diagram of an embodiment of the method wherein correspondence between players and the referent is determined from characteristic features extracted from their respective representations.

The method 200 of FIG. 2. starts at step 205 whereafter it proceeds to step 210 in which it selects a referent from a predetermined set of referents.

It can be understood that the referent can be one or more elements from a set including but not limited to representations of a persons, especially of celebrities, or representation of a fictitious persons including but not limited to computer generated persona, representations of players of the current or past games, and representations of persons who have consented to being used as referents in the game.

Next, in step 215, characteristic features are extracted from the referent selected in step 210. The said feature extraction can be performed using any one of a number of feature extraction algorithms extant in the literature on digital signal processing. For example, if the referent is a digital image, one of the simplest sets of extracted features may be a sequence of numbers encoding the raw pixel values of the said image. Alternately, the set of extracted features may be more sophisticated and use algorithms that first detect salient landmarks within the image such as the coordinates of the eyes, nose, mouth, etc., and then calculate features using wavelet measurements at these landmark locations. Likewise, the features may also comprise mel-cepstral coefficients from the referent's voice sample, a sequence of measurements characterizing the referent's biological attributes or a sequence of measurements characterizing referent's psychological attributes. The method 200 is independent of the actual feature extraction algorithm used in step 215. It is a mark of strength of the invention that often a compromise can be made between the degree of the sophistication of the feature extraction algorithm and the quality of the similarity measure ultimately obtained. For implementations using, for example, limited computing capability an algorithm suitable to this or other device limitations may be used with the inventive method. For an excellent discussion of several feature extraction algorithms and wavelet based signal processing, see “Digital Image Processing” by William K. Pratt, John Wiley and Sons, Inc., 2003.

In the next step, 220, representations are acquired of each of the players of the game. If the referent was a digital image, then the representations acquired in this step are photographs of each of the players. If the referent was a song-clip or voice sample, then the representations acquired in this step are song or voice samples of the players respectively. In the next step 225, features are extracted from each of the representations acquired in step 220. In the preferred embodiment step 220 uses the same algorithm that was used in step 215.

In step 230, each of the feature sets extracted in step 225 are in turn compared to the feature set extracted in step 215 of the referent selected in step 210. The said comparison between two feature sets can performed using any of a number of feature set comparison algorithms extant in the literature in computer science and statistics. For example, one of the simplest comparison algorithms may be a mean-squared-error metric, which calculates the sum of the squares of the differences between individual corresponding features in the two sets that are the object of comparison. The mean-squared-error metric calculates a measure of dissimilarity. The value calculated by the metric is larger for more dissimilar feature sets and must be interpreted accordingly. Likewise, a Euclidean distance metric may be used, in which each of the two feature set is interpreted as a point in high dimensional space, and the Euclidean distance between the points in this space represents the degree of dissimilarity between their feature sets. As noted in the discussion of step 215, the method 200 is independent of the exact similarity calculation or comparison algorithm used. It is often the case that a compromise can be reached between the degree of sophistication of the comparison algorithm and the quality of the similarity measure ultimately obtained. It can also be appreciated that the said comparison can be performed by human or robotic judges.

In step 235, scores are assigned to the players according to the degree of similarity calculated in step 230. In the preferred embodiment of the game, players are awarded more points for being judged more similar to the referent. In step 240, the assigned scores for each player are accumulated. In step 245 a decision is made whether another round is sought to be played. In the preferred embodiment the method queries the players if they desire to play another round. If they so desire, the sequence of steps from 210 to 245 is repeated. If the players do not seek to play another round or if the embodiment of the method disallows further rounds to be played, the method then proceeds to terminate at step 255 after declaring a winner at step 250.

The inventive method may be implemented to transform virtually any existing computing device into a gaming system capable of comparing representations of players with referents.

Further, the method taught herein enables an existing computing device to provide a facility to play a game according to the method without the need to purchase additional hardware or dedicated machinery.

The inventive method provides for implementing any of a number of variations of the underlying game. For example, a process of acquiring photographs of the players may be turned into an enjoyable and thrilling experience in itself by imposing time-limits for such image capture and transmission, by allowing or disallowing the use of cosmetics and make-up, by rewarding with points the person who captures each photograph in such a way that it is in their best interest to not take unfavorable photos of their competitors, by promoting the use of certain possibly co-branded products and accessories (e.g. lipstick, wigs, false eye-lashes, etc.) that the players can use to make themselves look more similar to the referent selected in step 110, etc.

In one embodiment, the score provided to the user is a single metric representing overall similarity. In another embodiment the calculated score is broken down into sub-scores for various components of the players' images. For example, “Player 1 has a nose that is most similar to that of Jack Nicholson. Player 2 has lips that are most similar to that of Jack Nicholson” etc. In another embodiment the scores from each of the components of the previous embodiment are weighted individually combined in some suitable manner such as addition to produce an overall score.

Those skilled in the art will appreciate that although the present invention has been described within the exemplary context of an image comparing or voice comparing game application, the methods of the present invention may also be implemented for use in conjunction with any game application that provides a similar game playing experience by making other biometric or psychometric comparisons including but not limited to singing voice, hair-color, smile, body temperature, heart-beat rate while under artificially induced stress, the number of stutters while reading an assigned difficult textual passage, or other measurable biological or psychological attributes or phenomena, potentially while under artificially induced stress.

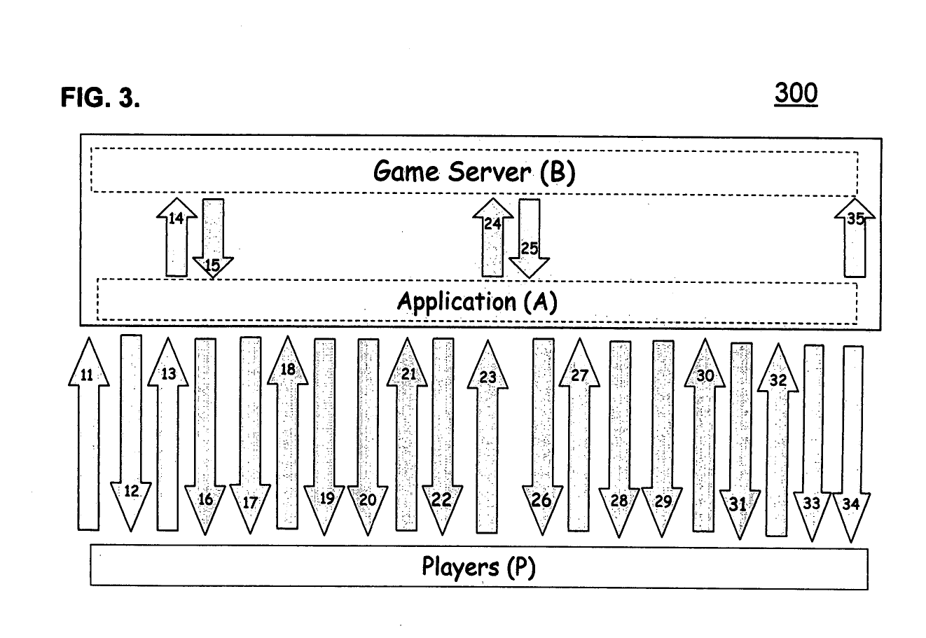

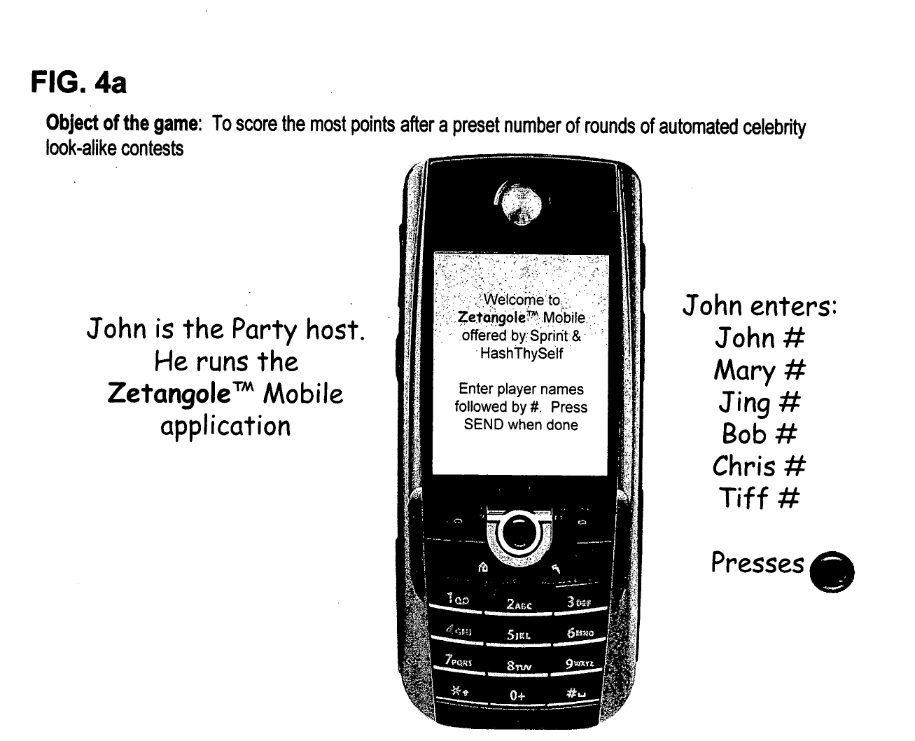

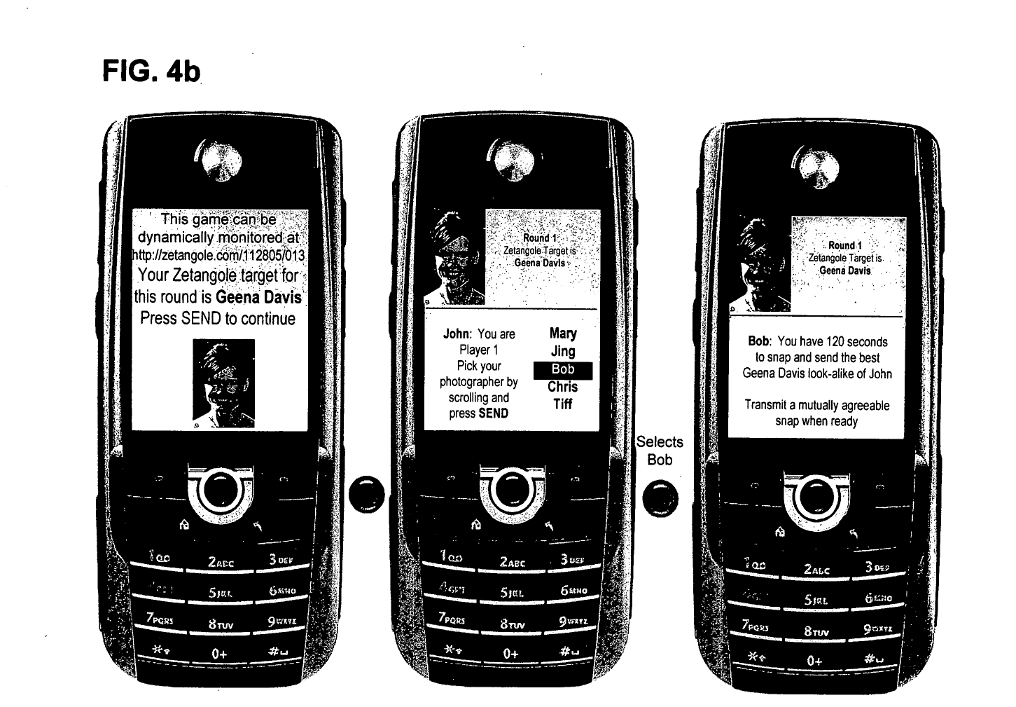

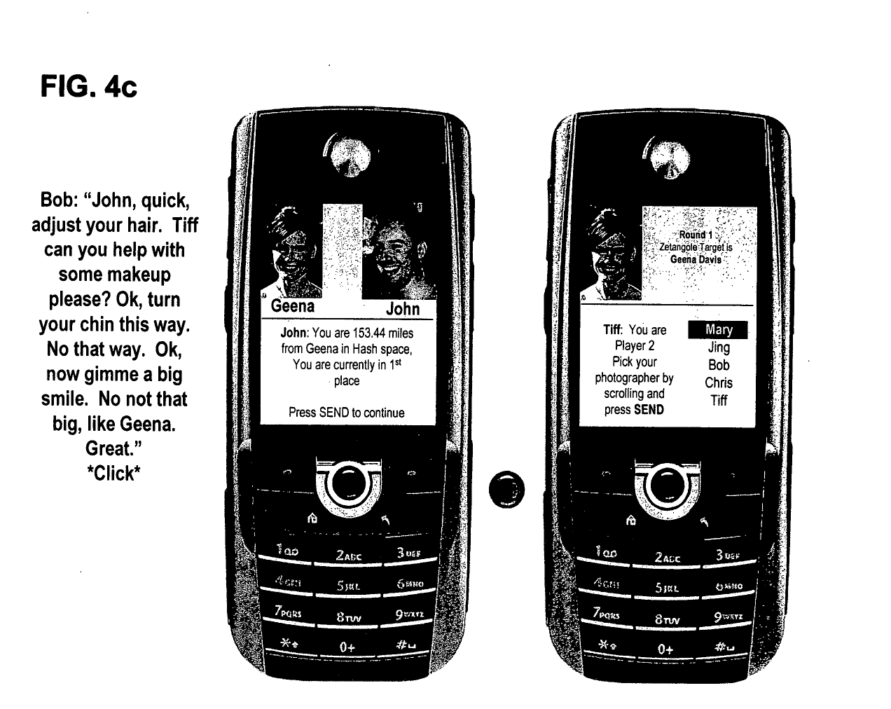

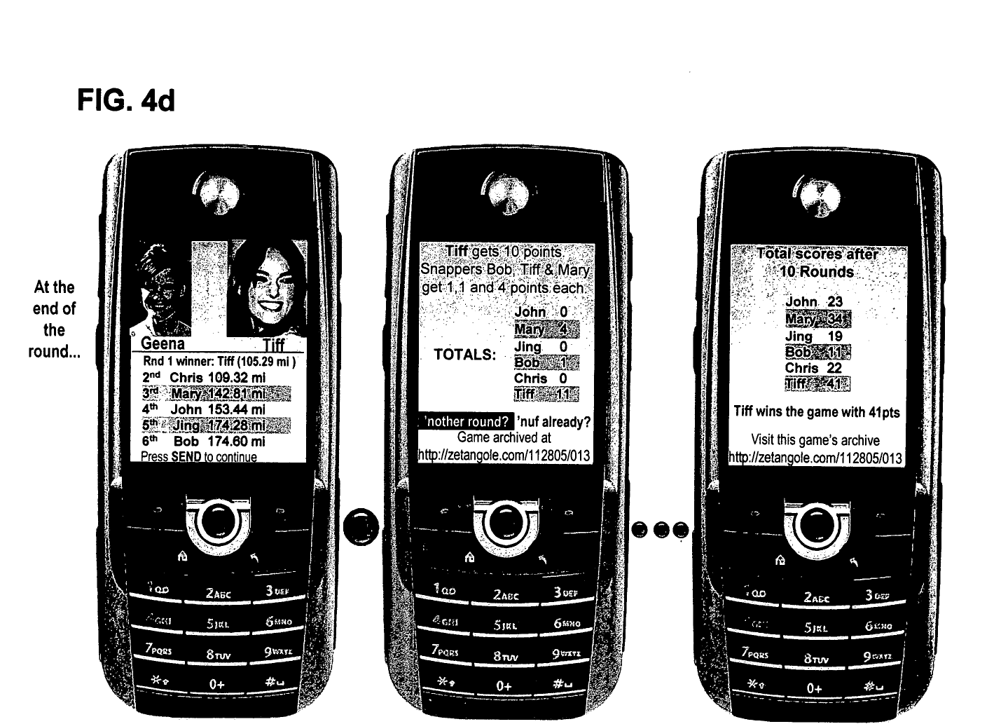

FIG. 3 depicts an exemplary architecture for implementing the game in a current embodiment. But it is understood that many other possible ways to architect the game system exist, and the depiction is not intended to limit implementation architecture within the scope of the invention. In the depicted architecture, it is assumed that the game is implemented in a distributed fashion and is restricted to using photographs as representations of the players and the referent. The first part, A, is the game application that interacts with the user. The second part, B, is a game management server that handles the back-end responsibilities associated with the game. By back-end responsibilities, we mean actions corresponding but not limited to managing multiple games from multiple game applications simultaneously, assigning unique game identifiers to each game, selecting and assigning data for each game, archiving each game, and calculating similarity or dissimilarity metrics between submitted media files. The interactions between the players, P, the application program A, and the game server, B, are depicted as block arrows named with numerals that represent the flow of events in time. That is, action 11 happens first, action 12 happens next and so on. For maximum clarity, it will be instructive to study FIG. 3 together with FIGS. 4 (a) through (d) inclusive in which example user-interface screens from a current embodiment are provided.

The game application (denoted by A) is assumed to run on a device to which the players (denoted by P) have ready access. This device may be, for example, a cellular phone, Personal Digital Assistant, or a personal computer with a web-cam. Moreover, the application program is assumed to connect to a separate entity in order to embody the functionality of the game. The entity (denoted by B) is the game management server. The functions of the game management server will become clear in the following discussion. B may reside on the same computer as the application, A, or be remotely located. The reader will also appreciate that in one embodiment, the role of B could be subsumed by the game application, A, itself. In yet another embodiment, the similarity computation algorithm embodied in B may reside in a separate entity altogether. The particular embodiment and depiction chosen here is for the purpose of elucidation only.

After a certain number of players congregate and decide to play the game, they start the game application A by launching it. This may be accomplished, for example, by selecting the icon for the game and double-clicking it, etc. The arrow labeled with the numeral 11 represents this action. In action 12, the game application asks the players to transmit their names or nicknames to it. Action 13 represents the act by the players of entering the said names into the device and ending the action with some sentinel action. In action 14, A transmits the player names to the game manager, B, which then proceeds to create a unique location where the information pertaining to this game will be stored. This location is used for both game-play as well as for maintaining a live-game-monitoring service that the depicted embodiment (see the mock-ups in FIGS. 4(a) through (d) inclusive) claims to provide. B then pre-selects a list of ten random celebrity images, constructs a unique game identifier and transmits them to A in action 15. The ten celebrity images are to be used by A in each of ten possible rounds in the game. Action 16 is a pseudo-action included for the purpose of depicting looping or iteration over each of the up to ten rounds. Assuming that each round is identified by a unique numeral from one to ten, the following sequence of actions is repeated for each round or until the user terminates the looping prematurely. In action 17, the application server selects a celebrity image, Ti, that was previously unused in this game, displays it to the player and awaits confirmation. In action 18, the player confirms the target selection. Again, action 19 is a pseudo-action for the purpose of depicting looping or iteration over each of the players in the group of players.

In action 20, A asks the player, Pj, to select his or her photographer. This step is important, though not critical, for the enjoyment of the game because it promotes fairness in play by giving players the freedom to select favorable photographers. Being selected as a photographer comes with a reward of some points for the photographer and thus it is in their own interest to not take unfair photographs since such an action could weigh against their being chosen as photographer subsequently. Therefore this variation of game-play in which points are awarded for being selected as photographer is claimed as a valuable alternative embodiment of the proposed game and this is the embodiment that is depicted in the accompanying FIGS. 3 and 4(a) through (d) inclusive.

In action 21, the player selects his or her photographer from among his or her play-mates and indicates the choice to A. In action 22 A asks the selected photographer, Cj, to photograph and send an image of the player Pj. Cj proceeds to photograph Pj and transmit a mutually agreeable image to A in action 23. A then transmits the image together with the image of the selected celebrity to the game manager, B, in action 24.

B responds with the similarity between the two given images in action 25. In action 26, A displays the result of the similarity computation, together with interim standings within the round, to the players and asks for confirmation. Action 27 represents the confirmation of this information by the players. Action 28 is a pseudo-action that allows looping. It simply changes Pj from the current player to the next player in the current round and repeats the sequence of actions from action 20 until all players have had a chance to be compared to the celebrity selected for this round. At this point, in action 29, A displays the end-of-round results in terms of some suitably and intuitively encoded similarity metric to the players. P confirms these results in action 30. In action 31, A displays the end-of-round results in points. In a current embodiment, the player judged to be most similar to the selected celebrity for the round gets ten points and a player gets one point each time he or she is selected to be a photographer by some other player. It is assumed that self-photography is not allowed in this embodiment of the game; but the reader will appreciate that numerous other scoring strategies are obviously conceivable, including but not limited to a different weighting of scores, and assigning points to more than just the player deemed most similar to the target celebrity. In action 31 also, A asks P if they desire to play another round. P indicates their answer to this question 32. In action 33, suppose another round is required; then A simply selects a hitherto unused celebrity image in this game, assigns it to Ti and repeats the sequence of actions from action 17 until either ten rounds have completed or the players choose to end after some earlier round. At the end of the game, in action 34, A displays the cumulative end-of game scores in points. In action 35, A sends an END-OF-GAME indication to the game server B.

Those skilled in the art will appreciate that although the present invention has been described within the exemplary context of a particular application, the methods of the present invention may also be implemented for use in conjunction with any application that provides a gaming opportunity based on similarity metrics.

Thus it is clear that that the invention provides a game that delivers an enjoyable and “addicting” playing experience that will furthermore significantly boost the sales of web-based cameras, digital cameras, microphones, cellular phones with cameras, biometric devices such as pulse meters, digital thermometers, etc., and boost revenues of telecom carriers by motivating cellular phone users to use the advanced features of their phone and the data network.

While various embodiments have been described above, it should be understood that they have been presented by way of example only, and do not impose limitation. Thus, the breadth and scope of a preferred embodiment should not be limited by any of the above-described exemplary embodiments, but should be defined only in accordance with the figures herein and following claims and their equivalents.

What is claimed is:

1. A method for a game for a plurality of players, the method comprising the steps of:
(a) selecting a referent from a predetermined set of referents;
(b) determining correspondences between each of the players and the referent;
(c) assigning scores to each player based, at least in part, upon the correspondence between the player and the referent;
(d) accumulating said scores for each player;
(e) optionally repeating steps (a), (b), (c) and (d) in sequence a plurality of times;
declaring a winner based, at least in part, upon the accumulated scores of the players.

2. The method of claim 1 wherein the referent comprises at least one member of a group comprising an image, an image of a likeness such as a caricature, voice-sample, hair-color, eye-color, skin-color, shape of smile, body temperature, heart-beat rate, number of stutters while reading an assigned difficult textual passage, other measurable biological attribute and other measurable psychological attribute of a person, wherein measurable means the quality of being able to be quantified.

3. The method of claim 2 wherein the said person is one of a group comprising celebrities, computer generated persona, fictitious characters, players of the game, players of past games and persons who have consented to being used as referents in a game.

4. The method of claim 1 wherein said correspondences are determined, at least in part, by a method comprising the steps of:
(a) extracting features from said referent;
(b) acquiring a representation of each of said players;
(c) extracting features from the representations of each of the players;
(d) determining the correspondence between the features extracted in steps (2a) and (2c).

5. The method of claim 4 wherein said representation of players comprises at least one member of a group comprising an image, an image of a likeness such as a caricature, voice-sample, hair color, eye color, skin color, shape of smile, body temperature, heart-beat rate, number of stutters while reading an assigned difficult textual passage, other measurable biological attribute, other measurable psychological attribute and an illustration of the referent created by the player.

6. The method of claim 4 wherein said features of said referent comprises at least one member of the group comprising wavelet measurements from the referent's image, mel-cepstral coefficients from the referent's voice sample, sequence of measurements of the referent's biological attributes and sequence of measurements of referent's psychological attributes.

7. The method of claim 4 wherein said features of said players comprises at least one member of the group comprising wavelet measurements from the player's image, mel-cepstral coefficients from the player's voice sample, sequence of measurements of player's biological attributes and sequence of measurements of player's psychological attributes.

8. A system to enable a plurality of players to play a game, the system comprising:
(a) a first means for presentation of referent to each of the players;
(b) a second means for acquisition of representations of each of the players;
(c) a third means for determination correspondences between the representations of each player and the selected referent.

9. The system of claim 8 wherein the system further comprises computer software capable of executing the logic of the game.

10. The system of claim 9 wherein the system comprises:
(a) a first means that is physically located on devices collocated with the players;
(b) a second means that is physically located on devices not collocated with the players;
(c) a third means for communication that allows information to flow between the first and second means wherein the first and second means, separately or together are capable of executing game play.

11. The system of claim 8 wherein said first means for presentation comprises at least one device selected from a group comprising a computer screen, speakers, tactile feedback equipment, a human artist and a robotic artist.

12. The system of claim 8 wherein said second means for acquisition comprises at least one device selected from a group comprising a camera, a microphone, bio-sensory equipment and human observers.

13. The system of claim 8 wherein said third means for computation comprises at least one device selected from a group comprising computer software, computer hardware, a combination of hardware and software such as an artificial neural network and human judges.

14. The system of claim 10 wherein the first means is a plurality of devices such that players need not be collocated.

15. The system of claim 10 wherein the first means is a device selected from a group comprising a computer, cellular phone, television, gaming console, wrist-watch and PDA.

16. The system of claim 10 wherein the third means for communication is a communication network comprising at least one entity selected from a group comprising the Internet, a local area network, a wide area network, a wireless communication network, a wired telephonic network and a wireless telephonic network.

17. The system of claim 10 wherein the second means is a device selected from a group comprising a computer, cellular phone, gaming console, a human judge and a robotic judge.

18. The system of claim 10 wherein the first means is a cellular phone.

19. The system of claim 10 wherein the first means is a personal computer.
